(19) United States
(12) Patent Application Publication
(10) Pub. No.: US 2025/0223918 A1
(43) Pub. Date: Jul. 10, 2025

(54) LOW-PRESSURE COOLING CIRCUIT

(71) Applicants: AMPERE S.A.S., Boulogne Billancourt (FR); WHYLOT, CAMBES (FR)

(72) Inventor: Robert YU, Guyancourt (FR)

(21) Appl. No.: 18/705,351

(22) PCT Filed: Nov. 2, 2022
(86) PCT No.: PCT/EP2022/080541

§ 371 Date: Apr. 26, 2024

(30) Foreign Application Priority Data
Nov. 2, 2021 (FR) 2111633

(51) Int. Cl. F01P 11/02; B60K 1/00

(52) U.S. Cl. CPC F01P 11/029; B60K 1/00; B60K 2001/006; B60Y 2400/607

(57) ABSTRACT

The invention relates to an expansion vessel for a cooling circuit of an axial-flux electric motor, comprising: —a receptacle suitable for containing a cooling liquid; —a deformable membrane which delimits two compartments in the receptacle and which is suitable for matching the shape of the surface of the cooling liquid contained in a first of said compartments; and —means for regulating the pressure in a second of said compartments.

### TECHNICAL FIELD OF THE INVENTION

The present invention relates generally to the cooling of electric or thermal machines.

It relates more particularly to an expansion vessel for a cooling circuit, comprising a receptacle suitable for containing a cooling liquid.

The invention finds a particularly advantageous application in the cooling of electric machines, and in particular in that of axial-flux electric machines.

It also relates to a motor unit including an electric motor and an electric motor cooling circuit, the inlet and outlet of which are connected to the electric motor and which comprises a cooling liquid pump, a heat exchanger, and an expansion vessel.

### PRIOR ART

An electric or hybrid motor vehicle includes an electric machine for its propulsion.

For example, the electric machine may be of the axial-flux type and include a casing which houses a disk-shaped rotor flanked by one or two stators.

Each stator includes a disk-shaped frame on one face of which teeth, and coils of electric wires wound around the teeth, are raised.

During its operation, such an electric motor emits a large quantity of heat, which needs to be discharged.

It is then known from the document FR2823382 to use oil for cooling the motor by circulating it between the motor coils (in spaces called “stator slots”). This solution is relatively effective because the oil has dielectric properties and can therefore come into direct contact with the coils to cool them.

On account of the increase in its temperature during the operation of the electric motor, the oil, which is not compressible, increases in volume. It is then known to use an expansion vessel for absorbing the differences in oil volume when the temperature of the electric motor varies.

Such an expansion generally includes a rigid receptacle, closed by a cap equipped with a overpressure valve, for discharging the air contained in the vessel when its pressure exceeds a threshold, and an underpressure valve for allowing the entry of air into the vessel when the pressure therein is below another threshold.

The pressure in such a vessel may then vary between the two thresholds, to the extent that the pressure of the cooling liquid in the circuit also varies.

The drawback is that it is then difficult to find a solution making it possible, when the pressure rises, to ensure satisfactory sealing in the electric motor (to prevent the oil from escaping from the path provided) and a homogeneous flow through the different stator slots (to obtain homogeneous cooling of the different coils of the motor).

### DISCLOSURE OF THE INVENTION

In order to remedy the drawback of the prior art cited above, the present invention proposes a solution wherein the pressure of the cooling liquid remains low, which reduces sealing problems.

More particularly, according to the invention, an expansion vessel as defined in the introduction is proposed, wherein a deformable membrane is provided which is suitable for matching the shape of the surface of the cooling liquid.

This deformable membrane separates the cooling liquid from the external air.

It is designed to be deformed in such a way as to absorb on its own the volume variations of the cooling liquid in the cooling circuit.

It is furthermore designed to be deformed without requiring a substantial increase in the pressure of the cooling liquid.

Thus, thanks to the invention, the pressure of the oil at the expansion vessel remains substantially equal to the atmospheric pressure. However, the pressure at each point of the cooling circuit is dependent on this pressure. Consequently, the pressure of the cooling liquid at any point of the electric motor remains limited and does not vary from one time to another. Hence, the sealing of the cooling circuit is easier to ensure.

Other advantageous and non-limiting features of the expansion vessel according to the invention, considered individually or according to any technically feasible combinations, are as follows:
said deformable membrane delimits two compartments in the receptacle, including one compartment suitable for containing the cooling liquid, and one compartment which has a venting opening;
said membrane is elastically stretchable;
said membrane is made of a flexible material and has folds or undulations.

The invention also relates to a motor unit as defined in the introduction, the expansion vessel of which is as cited above.

Advantageous and non-limiting features of the motor unit according to the invention, considered individually or according to any technically feasible combinations, are as follows:
the electric motor includes a casing, a rotor and a stator which is equipped with coils delimiting stator slots between them;
the casing delimits an annular manifold the inlet of which is connected to the outlet of the cooling circuit and which opens into each of the stator slots via separate openings;
the cooling liquid undergoes between the outlet of the annular manifold and the outlet of said openings a pressure loss which is strictly greater than that undergone by the cooling liquid during its passage in the stator slots;
the cooling liquid undergoes between the outlet of the annular manifold and the outlet of said openings a pressure loss which is strictly greater than that undergone by the cooling liquid between the outlet of the openings and the inlet of the cooling circuit;
separating means are provided for isolating the cooling liquid flow paths between each opening and each stator slot;
a baffle is provided between each opening and each stator slot, forcing the liquid to change direction at least twice;
the cooling liquid is an oil.

Of course, the different features, variants and embodiments of the invention may be associated with one another according to various combinations to the extent that they are not incompatible with or exclusive of one another.

### DETAILED DESCRIPTION OF THE INVENTION

The following description with reference to the appended drawings, given as non-limiting examples, will explain the scope of the invention and how it could be carried out.

In the appended drawings:

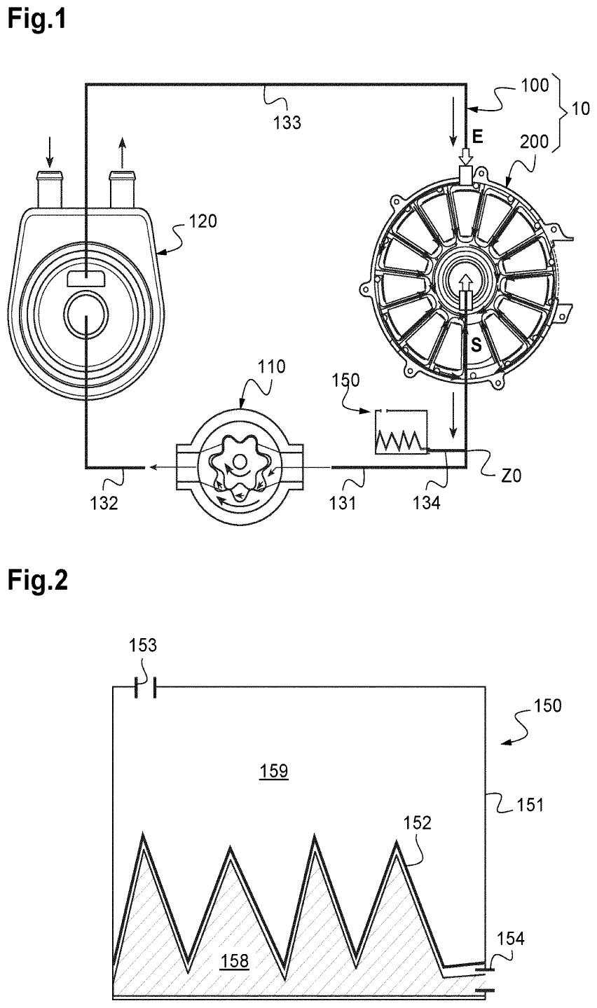

FIG. 1 is a schematic view of a motor unit according to the invention;

FIG. 2 is a schematic view of the expansion vessel of the motor unit of FIG. 1;

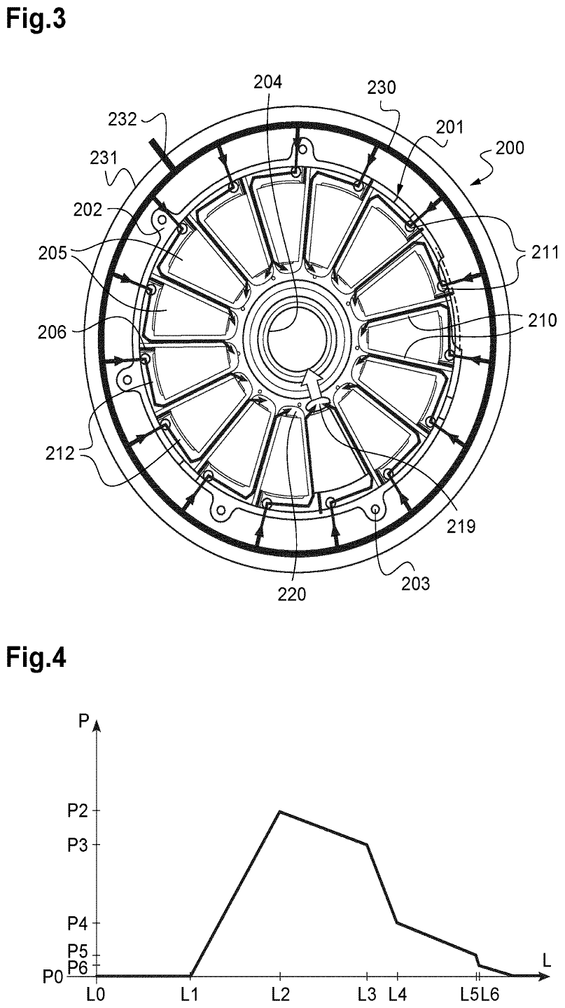

FIG. 3 is a schematic view of the electric motor of the motor unit of FIG. 1; and

FIG. 4 is a graph illustrating the pressure variation of the cooling fluid along the cooling circuit and the electric motor of the motor unit of FIG. 1.

In FIG. 1, a motor unit 10 which comprises an electric motor 200 and a cooling circuit 100 of the electric motor 200 is represented.

The cooling circuit 100 essentially includes a pump 110 and a heat exchanger 120 which are connected in series with the electric motor 200 by means of ducts, as well as an expansion vessel 150 which is connected to one of the ducts cited above.

The pump 110 could be presented in various forms. It consists here of a gear type pump, the inlet of which is directly connected to the electric motor 200 by a first duct 131 and the outlet of which is directly connected to the heat exchanger 120 by a second duct 132.

The heat exchanger 120 has for its part an outlet directly connected to the electric motor 200 by a third duct 133. It could consist of an air or water exchanger, wherein the cooling of the cooling liquid circulating in the cooling circuit 100 would therefore be carried out by air or by water.

This heat exchanger 120 and the pump 110 being well-known to a person skilled in the art, they will not be described further here.

The expansion vessel 150 is for its part connected by a fourth duct 134 to the first duct 131.

An embodiment of this expansion vessel 150 is more specifically represented in FIG. 2.

In this embodiment, the expansion vessel 150 includes a receptacle 151 of any shape, for example parallelepipedal, suitable for receiving cooling liquid. This receptacle 151 is for example made of plastic, of one piece or of several elements assembled together.

It is sealed, except at its openings 153, 154 described hereinafter.

This receptacle 151 houses internally a deformable membrane 152 which delimits two compartments 158, 159 in the receptacle 151, separated tightly.

One of these compartments, called the lower compartment 158, is provided to only receive cooling liquid. It has an opening 154 on the edge of which the fourth duct 154 is connected.

The other of these compartments, called the upper compartment 159, is for its part provided to be filled with air.

The deformable membrane 152 then serves as an interface between the cooling liquid and the air.

It is therefore solid (i.e., devoid of a hole) and is attached tightly on its entire rim to the inner face of the receptacle 151.

This membrane is described as “deformable” in that it does not obstruct the filling or draining of the lower compartment 158. More specifically here, during the operation of the electric motor 200 at full load, when the cooling liquid increases in volume until a maximum volume is reached, the deformable membrane 152 is designed to be deformed sufficiently easily in such a way that the cooling liquid pressure undergoes little or no variation (less than 0.1 bar).

In practice, it could be provided that the membrane is stretchable, in the manner of an inflatable balloon.

However here, as shown by FIG. 2, the deformable membrane 152 is somewhat flexible and has an irregular shape, with folds or undulations, which allows it to match the shape of the surface of the cooling liquid, regardless of the volume of liquid contained in the first compartment 158.

It could thus for example consist of a membrane made of plastic or rubbery material, which would match perfectly (with a minimum of folds) the shape of the top of the receptacle 151 if the latter was filled.

A means 153 for regulating the air pressure in the upper compartment 159 is provided to ensure that the pressure of the air contained therein undergoes little or no variation (less than 0.1 bar).

In practice, this regulation means is a mere venting opening 153 which, when the level of cooling liquid rises in the receptacle 151, allows the air contained in the upper compartment 159 to be discharged in such a way that its pressure remains equal to the atmospheric pressure.

At this stage, it may be noted that the filling of the cooling circuit 100 may be performed via a cap provided not in the expansion vessel, but at a distance therefrom. At the start of filling, it will be necessary to ensure that the lower compartment 158 does not contain air because it is not filled with air. For this, the upper compartment 159 may be placed under air pressure, for example.

The electric motor 200 to be cooled is preferably an axial-flux type motor.

A part of this motor is represented in FIG. 3.

This electric motor 200 conventionally includes a motor shaft, a casing 231, one or preferably two stators 201 fastened to the casing, and a disk-shaped rotor, which is located between the stators and which is fastened to the motor shaft. This configuration makes it possible, when the stators are supplied with electric current, to rotate the motor shaft about an axis of rotation.

Hereinafter in this disclosure, only one of the stators will be discussed (the two stators being identical or similar).

As shown in FIG. 3, this stator 201 includes a disk-shaped flange 202 centered on the axis of rotation, which is perforated at its center by a central opening 204 for passing the motor shaft. It is also perforated on its periphery by openings 203 for fastening the flange to the casing 231.

The flange 202 thus has a substantially circular peripheral edge, and two planar faces. One of these faces, that oriented toward the rotor, bears teeth 205 (or “studs”) projecting from the flange 202.

These teeth 205, here 13 in number, are distributed all around the central opening 204.

They have cross-sections transversal to the axis of rotation of overall isosceles trapezoid shape.

They are designed to allow the winding of a conductive electric wire around each of them, so as to form coils 220. Once supplied with electric current, these coils 220 make it possible to generate a magnetic field oriented parallel with the axis of the rotation, in such a way as to force the rotor to rotate about this axis.

The coils 220 wound on neighboring teeth 205 are located at a reduced, but non-zero, distance from each other, and they therefore delimit between them a space hereinafter called “stator slot 210”. These stator slots 210 extend lengthwise along a radial axis with respect to the axis of rotation, and they have substantially identical cross-sections (within manufacturing dispersions).

The cooling circuit 100 cited above is then designed to cool the cooling liquid before passing it through the stator 201 of the electric motor 200, via these stator slots 210.

The cooling liquid then used is preferably oil, which makes it possible to pass this liquid against the electric wire coils 220 without risking electrical problems.

The casing 231 of the electric motor 200 then has an inlet 232 connected to the third duct 133, and an outlet connected to the first duct 131.

As disclosed above, this casing 231 delimits a chamber for accommodating the rotor and the stators. For this, it includes a lateral wall substantially revolving about the axis of rotation.

This lateral wall is partially hollow, in such a way as to delimit internally an annular space, called oil manifold 230, into which the oil inlet 232 opens and which makes it possible to distribute the oil to each of the stator slots 210.

This oil manifold 230 preferably has rotational symmetry about the axis of rotation.

The cross-section of this oil manifold may be substantially round or square. However, for size reasons (the thickness of the lateral wall of the casing being limited), it will preferably be of flattened shape (rectangular or oval).

Because this oil manifold 230 is defined inside the lateral wall of the casing 131, which may for example be obtained from foundry, the pressure prevailing therein does not pose any problem in respect of its sealing.

The oil manifold 230 is connected to the stator slots 210 via openings (not shown) provided in the casing 231 and via openings 211 (seen in FIG. 3) which are formed in the flange 202 of the stator 201 and the number of which is equal to the number of teeth 205.

The oil, when it comes out of these openings 211, is located in a space which extends over the outer rim of the coils 220 and which is delimited, on one side, by these coils, and, on the other, by the casing 231 (or by a sealing wall).

Means are then provided to separate this space into the same number of angular sectors as coils 220. These means are here formed by separating partitions 206.

Thanks to these partitions, each stator slot 210 is supplied with oil via its own opening 211.

Each opening 211 has a reduced size, which has the function of creating a substantial pressure loss on the oil flow.

This pressure loss created by the opening 211 may be supplemented by a reduction in the cross-section of the fluid flow (called nozzle orifice) created in the flow portion between the outlet of the manifold and the opening 211. The advantage of this solution is that it does not overly reduce the diameter of the opening 211, because the smaller the diameter, the higher the velocity of the fluid at the outlet of the opening 211. An excess velocity (greater than 3 m/s) may create damage on the coils which have a fragile coat of varnish for their electrical insulation.

Thanks to the architecture used, the oil flow rates in the different stator slots 210 are substantially identical.

The cross-section of these openings is for example between 4 and 20 mm², whereas that of the oil manifold is between 50 and 200 mm².

This pressure loss furthermore has the effect of reducing the oil pressure in the stator slots 210, to such an extent that it is easier to render these slots tight.

On account of manufacturing dispersions, it is possible that the cross-sections of the stator slots 210 may not all be exactly identical.

The openings 211 and the separating partitions 206 are then arranged with respect to the inlets of the stator slots 210 in such a way as to form baffles 212 between each opening 211 and each slot inlet, forcing the oil to change direction twice. These baffles 212 then make it possible to homogenize the oil flow rate between the different stator slots 210, and therefore ensure homogeneous cooling of the different coils 220.

The oil, when it comes out of these stator slots 210, finds itself in a space delimited between the coils 220 and the motor shaft (or between sealing walls). It may then come out via a single outlet 219 of large cross-section, connected to the cooling circuit 210.

It thus has at its outlet of the slots a larger space than that which it had to pass through the stator slots 210. Once it has come out of the stator slots 210, it then undergoes a reduced pressure loss.

In FIG. 4, the variations of the pressure P of the oil when it flows along the cooling circuit 100 and in the electric motor 200 have been represented.

In this graph, the x-axis L represents the curvilinear abscissa of the path followed by the oil, and the y-axis P represents the pressure of the oil.

At the x-axis point L0, which corresponds to the point of intersection of the first and fourth ducts 131, 134 (annotated Z0 in FIG. 1), the pressure of the oil is equal to the atmospheric pressure P0 thanks to the specific architecture of the expansion vessel 150.

From the x-axis point L1, which corresponds to the inlet of the pump 110, the pressure of the oil increases progressively up to a pressure P2 at the outlet of the pump (at the x-axis L2).

When the oil passes through the heat exchanger 120 (between the x-axis points L2 and L3), the pressure P decreases progressively.

At its inlet into the electric motor 200, the oil still has a high pressure P3.

On account of the reduced cross-section of the openings 211 provided in the stator 201 (supplemented optionally by adjustments), the oil will undergo a substantial pressure loss, such that its pressure at the inlet of the stator slots 210 (at the x-axis point L4) will have decreased substantially to a pressure P4. As explained above, this substantial pressure loss will make it possible to ensure that the oil flow rate is substantially the same in all the stator slots 210. This will furthermore make it possible to ensure the sealing of the oil flow in the motor.

The pressure P4 then being reduced, the flow of the oil in the slots will generate a lower pressure loss than that generated by the openings 211 (and any adjustments), to such an extent that at the outlet of the slots (x-axis L5), the pressure P5 is such that:

$$P 4 - P 5 < P 3 - P 4 \qquad [ Math . 1 ]$$

As disclosed above, the outlet of the slots is designed to generate minimal pressure losses, to such an extent that at the outlet opening 219 (x-axis L6), the pressure P6 is almost equal to the atmospheric pressure.

Preferably, this may be written as:

$$P 4 - P 6 < P 3 - P 4 \qquad [ Math . 2 ]$$

The present invention is in no way limited to the embodiment described and represented, but a person skilled in the art will be able to provide any variant according to the invention.

The different variants described hereinafter may, insofar as possible, be combined with each other.

According to a first variant, the expansion vessel could include a bowl-shaped receptacle, closed on the top by the deformable membrane. The deformable membrane would then no longer be in a closed enclosure, but would be directly in contact with the exterior.

According to a second variant, the receptacle of the expansion vessel could be formed by the deformable membrane per se, which would then be presented in the form of an inflatable balloon attached to the vehicle chassis.

According to a third variant, the electric motor could be, not axial-flux, but radial-flux. Indeed, such a motor includes coils of electric wire wound around radial axes, which delimit between them slots through which it is possible to pass a cooling liquid.

According to a fourth variant, the cooling liquid could be, not oil, but water. In this variant, it is then necessary to provide means for tightly isolating the water from the electric coils.

According to a fifth variant, the cooling circuit could be equipped with an expansion vessel making it possible to flush air bubbles out of the cooling liquid.

This degassing vessel may optionally be equipped with a cap to allow the filling of the cooling circuit with oil.

For example, the degassing vessel may include an inlet and an outlet of oil, and be connected to the cooling circuit 100 in parallel with the electric motor 200 (with the inlet connected to the third duct 133 and the outlet connected to the first duct 131).

1. Expansion vessel for a cooling circuit including a receptacle suitable for containing a cooling fluid,
wherein the expansion vessel includes a deformable membrane which is suitable for matching the shape of the surface of the cooling liquid.

2. Expansion vessel according to claim 1, wherein said deformable membrane delimits two compartments in the receptacle, including one compartment suitable for containing the cooling liquid, and one compartment which has a venting opening.

3. Expansion vessel according to claim 1, wherein said membrane is elastically stretchable.

4. Expansion vessel according to claim 1, wherein said membrane is made of a flexible material and has folds or undulations.

5. Motor unit including an electric motor and a cooling circuit for cooling the electric motor, the inlet and outlet of which are connected to the electric motor, said cooling circuit comprising:
a cooling liquid pump,
a heat exchanger, and
an expansion vessel.

6. Motor unit according to claim 5, wherein the electric motor includes a casing, a rotor and a stator which is equipped with coils delimiting stator slots between them, wherein the casing delimits an annular manifold the inlet of which is connected to the outlet of the cooling circuit and which opens into each of the stator slots via separate openings.

7. Motor unit according to claim 6, wherein the cooling liquid undergoes between the outlet of the annular manifold and the outlet of said openings a pressure loss which is strictly greater than that undergone by the cooling liquid during its passage in the stator slots.

8. Motor unit according to claim 6, wherein separating means are provided for isolating the cooling liquid flow paths between each opening and each stator slot.

9. Motor unit according to claim 6, wherein a baffle is provided between each opening and each stator slot, forcing the liquid to change direction at least twice.

10. Motor unit according to claim 5, wherein the cooling liquid is an oil.

11. Motor unit according to claim 6, wherein the cooling liquid undergoes between the outlet of the annular manifold and the outlet of said openings a pressure loss which is greater than that undergone by the cooling liquid between the outlet of the openings and the inlet of the cooling circuit.
